(19) United States
(12) Patent Application Publication
(10) Pub. No.: US 2012/0291056 A1
(43) Pub. Date: Nov. 15, 2012

(54) ACTION ENABLED AUTOMATIC CONTENT PREVIEW SYSTEM AND METHOD

(75) Inventor: Patrick J. Donoghue, Sea Cliff, NY (US)

(73) Assignee: CSC Holdings, LLC, Bethpage, NY (US)

(21) Appl. No.: 13/105,272

(22) Filed: May 11, 2011

(51) Int. Cl. H04N 7/16; H04N 5/445

(52) U.S. Cl. 725/5; 725/41

(57) ABSTRACT

Systems and methods for providing a sequence of automatic previews of items in a list of content assets. In an embodiment, a system provides a user with the ability to select actions on the asset associated with a preview being currently presented without interrupting playback of the current preview or sequence. Actions include, but are not limited to, retrieving further information on an associated asset, adding the asset to a set for later viewing or purchase, scheduling the asset for future recording, and retrieving a set of related assets. In embodiments, the system can retrieve and display asset information such as genre, ratings, reviews, synopses, and contributors such as cast members, cinematographers, writers, directors, and producers. Related assets can be determined based on retrieved asset information. In embodiments, the content assets include, but are not limited to, motion pictures, pay per view content, television programs, media preview/viewing content, and DVDs.

### FIELD OF THE INVENTION

Embodiments relate generally to providing previews of program material, and more particularly to providing a sequence of automatic, interactive previews of media items in a set of content assets.

### BACKGROUND OF THE INVENTION

Conventional motion picture theaters have long played a sequence of film previews prior to the beginning of a movie showing, as an advertising mechanism. The set and order of previews shown are fixed by the operator of each movie theater, for all viewers, and cannot be changed for individual users based on their interests or preferences. Furthermore, no mechanism exists for the viewer to take action on the displayed previews, aside from making a mental note that they might be interested in seeing a particular film being previewed.

Program material including audio or video programs can be experienced on a variety of navigation and playback devices, including digital video recorder (DVR) devices, digital video disc (DVD) devices, computer-implemented video and audio playback devices, mobile multimedia devices, and set top box devices. A set top box (STB) can be deployed at a user's household to provide the user with the ability to control delivery of video programming distributed from a provider.

Historically, traditional video on demand (VOD) systems have used nested menus to facilitate navigation through video assets, such as pay-per-view movies, sporting events, and other video assets, that are available on an ‘media preview/viewing basis.’ More recently, cable and satellite systems have added a search functionality to VOD systems, thus enabling users to find certain video assets by keyword searches.

While such techniques make it possible for a user to discover video assets of personal interest, they are nonetheless cumbersome to navigate, in that a user considering multiple assets for purchase or viewing, who wishes to preview multiple items, must typically undertake several steps in order to separately and manually preview each asset. For example, using conventional VOD systems, in order to view previews of assets appearing in a single set (such as within a single VOD menu category, such as “Comedy,” or within a single set of search results), a user must typically select a first asset, then click a button to initiate a preview, and then when the preview is completed, or when they don't want to see any more of the preview, the user must subsequently click one or more buttons to navigate to a second asset and repeat the process.

Internet-based video and DVD providers, such as HULU™ and NETFLIX™, have developed various user interface mechanisms to improve the process of finding and discovering content, yet if they facilitate viewing previews at all, they still have not made it any easier to view a sequence of previews for a set of assets of interest to a particular viewer, or to usefully act upon those previews while the sequence of previews continue to play. Accordingly, an overall user experience can be degraded for users of conventional VOD systems and Internet-based providers having delays associated with requiring sequential, manual previews of content assets.

What is needed are systems, methods, and computer program products that enable viewers to generate a set of media of potential interest, and to easily view previews of the media. What is further needed are systems, methods, and computer program products that provide the ability to easily act upon media previews without interrupting preview playback.

### BRIEF SUMMARY OF THE INVENTION

Embodiments of the invention comprise methods, systems, and computer program products that generate a set of assets of potential interest to a viewer. In an embodiment, a system incorporates conventional menus, genres, keyword searches, and keyword clouds in order to generate a set of media content. Embodiments incorporate additional techniques such as a mood-based search, ‘stream of consciousness’ navigation, predicted ratings based on user characteristics in a user profile, and measures of similarity between media items (i.e., media assets). By using such techniques, a user is enabled to generate a set of media items of potential interest. In an embodiment, the system ranks or orders the media items based on predicted relevance or interest level for the viewer. In another embodiment, the system may enable the user to sort or manually order the assets.

In one embodiment, upon generating the set, system provides the ability to begin playback of a sequence of previews for the identified assets. In another embodiment, the system may automatically begin this playback. In either of these embodiments, the system automatically and substantially continuously plays back the preview for the next asset in the set, after the preview for a prior asset in the set completes. This automatic playback process may continue cyclically at the beginning of the set, once the end of the set has been reached. Alternatively, the system may terminate automatic playback upon completing the preview for the last media item in the set.

According to an embodiment, the system provides the user the ability to manually navigate amongst previews, while the sequence is playing. For example, the system may provide a next and a last control, that enable the user to skip to the next preview in the set, before completing the current preview, or to skip back to the prior preview, respectively. The system may also provide the ability to skip directly to non-contiguous previews in the set, for example, by enabling the user to manually select a new asset to preview from the set.

In an embodiment, while a preview is playing, the system enables the user to perform useful actions related to the asset currently being previewed. Some of these actions may terminate the sequence of previews. For example, the system may provide an “Order” action which, if executed during a preview, automatically terminates the preview in order to begin the process of purchasing and viewing the associated asset. As would be apparent to those skilled in the art, the term “Order” refers to ordering media assets, including, but not limited to pay per view (i.e., rentals) and free assets. Thus, an Order action to order an asset does not imply a purchase of an asset.

Some of the available actions, however, may be executed without interrupting the preview playback sequence. For example, the system may provide an “Info” action enables to the user to display a written synopsis, cast, etc. of the asset currently previewing, without interrupting the playback of the sequence of previews.

The system may also provide an “Add to cart” or “Add to wish list” action that automatically adds the asset associated with the current preview to a set for later use by the user, without interrupting the playback of the sequence of previews. Thus, a user may be enabled to watch a continuous sequence of previews, selectively choosing and instructing the system to recall those that he is interested in viewing at some time, without interrupting the sequence of previews.

In a system where some or all of the previews are for available future programming, the system may provide a “Record” action, enabling the user to schedule future recording(s) of the asset (or assets, in the case of a series) associated with the current preview.

In addition, the system may enable the user to generate new sets of assets related to the current preview. For example, the system may enable the user to generate a set of assets that are similar to the asset associated with the current preview, or with a particular cast member, director or writer in common. The system may enable the user to view one or more of these related sets, before choosing to terminate the current sequence of previews (in order to begin a new sequence of previews for a selected related set).

In one embodiment, certain actions may be configured to terminate the current preview and skip directly to the next preview in the sequence. For example, an “Add to cart” action may be configured to automatically skip to the next preview after adding the asset associated with the current preview to the user's cart.

Additional embodiments of the invention include a system implementing a variety of additional actions, including offline actions such as ordering rental or purchase DVDs for shipment or purchase of theater tickets. The system may also handle a variety of media types in addition to video, including, but not limited to, audio, mixed media, and interactive media such as video games.

### BRIEF DESCRIPTION OF THE DRAWINGS/FIGURES

The accompanying drawings are included to provide further understanding, are incorporated in and constitute a part of this specification, and illustrate embodiments that, together with the description, serve to explain the principles of the invention. In the drawings:

FIG. 1 is a block diagram illustrating an architecture of a content asset preview system, according to an embodiment of the invention.

FIGS. 2-7 depict a graphical user interface (GUI) for a system that automatically displays interactive previews of media content, according to an embodiment of the invention.

FIG. 8 is a flowchart illustrating steps by which action-enabled content previews can be displayed, in accordance with an embodiment of the present invention.

FIG. 9 is a block diagram of an exemplary computer system on which embodiments can be implemented.

The present embodiments will now be described with reference to the accompanying drawings. In the drawings, like reference numbers may indicate identical or functionally similar elements.

### DETAILED DESCRIPTION

The following detailed description of the present invention refers to the accompanying drawings that illustrate exemplary embodiments consistent with this invention. While the present invention is described herein with reference to illustrative embodiments for particular applications, it should be understood that the invention is not limited thereto. Those skilled in the art with access to the teachings provided herein will recognize additional modifications, applications, and embodiments within the scope of the invention and additional fields in which the invention would be of significant utility. Therefore, the detailed description is not meant to limit the invention. Rather, the scope of the invention is defined by the appended claims.

Glossary

The following definitions are offered for purposes of illustration, not limitation, in order to assist with understanding the discussion of various embodiments that follows.

As used herein, in an embodiment, the term set top box (STB) refers to a device deployed at a viewer's household or business (such as a subscriber or customer premise) to provide the viewer with the ability to control delivery of video programming from a provider. The viewer can issue control commands to the STB, for example, powering on the STB, tuning to a specific channel, and tuning to other specific channels over time. A customer can also send and receive data to and from the provider, for example, via an Internet connection. A viewer may simultaneously, but separately, interact with the Internet and video programming. For example, a viewer can access the Internet in response to video programming, either separately through a computing device with Internet connectivity, or through a browser-enabled STB.

Embodiments of the present invention also can be applied to various navigation devices and platforms used to preview and select media content. Such navigation devices can be components of platforms including personal computers, mobile telephones, personal digital assistants (PDAs), tablets (e.g., Apple IPAD™), laptops, a portable media devices such as an Apple IPOD™, Internet Protocol (IP)-based telephones using voice over IP (VOIP), digital video recorders (DVRs), remote-storage DVRs, video media preview/viewing systems, interactive TV systems, and other systems capable of receiving and displaying media content and/or utilizing a network connection such as the Internet. A non-limiting example of a navigation device is the Apple TV device. References to a STB should therefore be interpreted to include these navigation devices and other similar systems involving display of media previews and content, and viewer input.

As used herein, in embodiments, the terms “viewership” and “viewer” broadly refers to individual viewers, individual users of an STB, a device used to preview a program, an STB, and/or households. Thus, viewership and community rating information or data can include data related to groups of users, STBs, households, navigation devices, or viewing devices.

Unless specifically stated differently, in an embodiment, a user is interchangeably used herein to identify a human user, a subscriber, a customer, a viewer, a software agent executing on behalf of a user, or a group of users and/or software agents. Users may be members of user populations (i.e., groups or sets), wherein the sets are related to a specific provider, type or tier of service subscribed to, a geographic area (i.e., users in a certain country, region, postal code, and/or state/province) or demographic grouping (i.e., users of a certain age range, income range, or gender. Besides a human user who is a member of a set, an STB, software application, or agent may be a member of a set. Accordingly, unless specifically stated, the term “user” as used herein does not necessarily pertain to a human being. A user may be represented by a user ID or account number. A user may also be represented by unique ID of a STB associated with the user. Users can have login credentials associated with them. Login credentials can include, but are not limited to, a user name, a password, and a personal identification number (PIN).

Unless specifically stated differently, in an embodiment, the terms “media asset” and “media item” are interchangeably used herein to identify any media asset, including but not limited to, subscription video on demand (SVOD) assets, pay-per-view video on demand (VOD) assets (i.e., rental assets such as movies), currently-airing or future-scheduled linear broadcast programs, free assets, a film or live production shown in theaters, physical media items such as DVDs, and software programs such as video games.

Additional acronym definitions are provided in Table 1. The acronym definitions listed in Table 1 are provided for the purpose of illustration, not limitation, in order to assist with understanding the discussion of various embodiments that follows.

TABLE 1
Acronym Definitions

| Acronym | Definition |
|---|---|
| DVR | Digital Video Recorder |
| MC | Movie cart/Asset cart (i.e., VOD titles |
| | currently selected for preview and/or |
| | purchase) |
| MVX | Media/Video Explorer |
| SVOD | Subscription On Demand |
| UI | User Interface |
| VOD | Video On Demand |

While the present invention is described herein with reference to illustrative embodiments for particular applications, it should be understood that the invention is not limited thereto. Those skilled in the art with access to the teachings provided herein will recognize additional modifications, applications, and embodiments within the scope of the invention and additional fields in which the invention would be of significant utility.

### System Embodiment

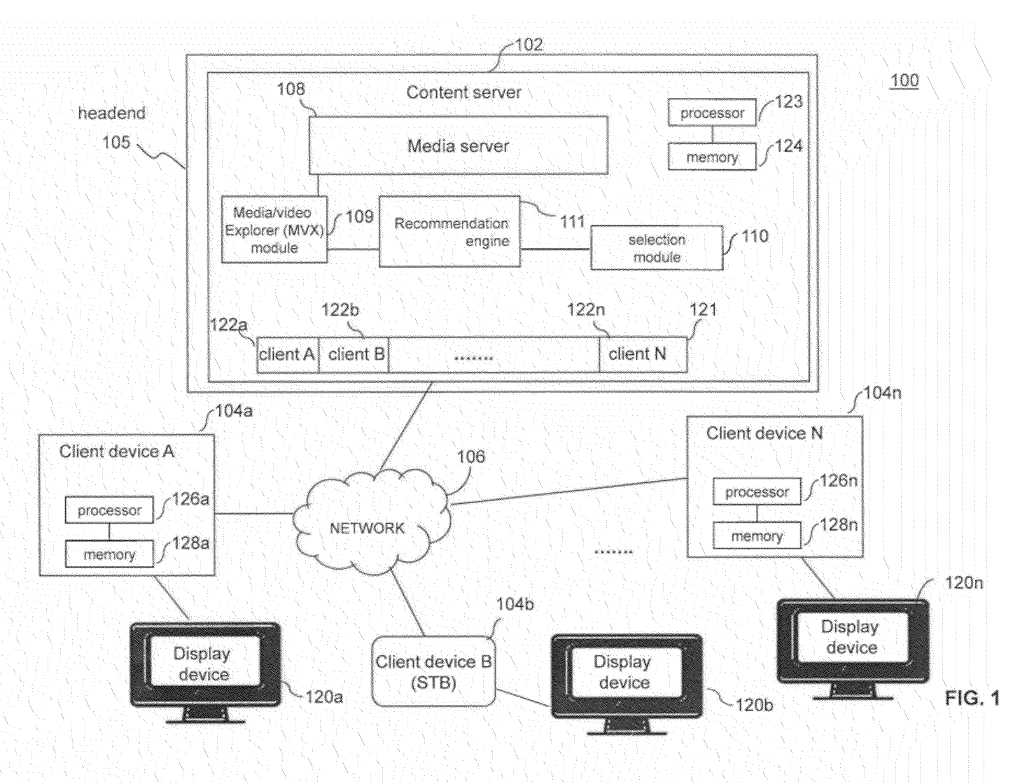

FIG. 1 illustrates an example system 100 to provide media preview/viewing services according to an embodiment of the invention. System 100 includes a content server 102, client devices 104a-n and network 106. Client devices 104a-n are coupled to content server 102 via network 106.

Content server 102 includes a media server 108 and a processor 112 coupled to memory 114. In the example embodiment depicted in FIG. 1, a media/video explorer (MVX) module 109 is hosted on content server 102. In an alternative embodiment, MVX module 109 may be separate from and external to content server 102. In one embodiment of the present invention, MVX module 109 is implemented as an application module operating on client device 104. Content server 102 may also include a queue 121 to queue media preview/viewing requests to client devices 104 (i.e., to facilitate unicast streaming delivery of video previews). For example, content server 102 may include multiple queues for multiple clients 104a-n. Each of client devices 104 include a processor 126 coupled to a memory 128.

FIG. 1 illustrates a block diagram of the architecture of exemplary content asset preview system 100 according to an embodiment. Asset preview system 100 includes headend 105, network 106, and a plurality of client devices 104a-104n. In an embodiment, client devices 104 comprise one or more navigation devices, such as, but not limited to a set top box (STB). Exemplary STB client device 104b can include, without limitation, an Internet Protocol (IP)-based (i.e., IPTV) STB. Embodiments are not limited to this exemplary STB interfacing with network 106, and it would be apparent to those skilled in the art that other STBs and navigation devices can be used in embodiments described herein, including, but not limited to, personal computers, mobile devices such as smart phones, laptops, tablet computing devices, digital video disc (DVD) devices, or other devices capable of video and audio playback. Many additional clients 104a and STBs 104b can be used with the system 100, although only one STB 104b is illustrated in FIG. 1. In an embodiment, a client device 104 may be integrated with a display device 120, so that the two form a single, integrated component.

As shown in FIG. 1, STB 104b is coupled to a headend 105 through network 106. Although not illustrated, additional STBs can be coupled to the headend 105 via the network 106, such that aggregated data can be collected from multiple STBs. In the example embodiment depicted in FIG. 1 content server 102 is located within headend 105. Although not depicted in FIG. 1, in an alternative embodiment, content server 102 can be located separately from headend 105. Client 104a and STB 104b receive operational commands from a user, including commands to initiate previews corresponding to media assets (i.e., media items). A remote control (not shown) or other input device may be used to control operation of STB 104b. Some STBs may have controls thereon not requiring the use of a remote control. The remote control is configured with buttons to control the STB 104b, including play, order, add to cart, info, view cart, preview similar media assets (i.e., more like this), etc. In an embodiment, the cart is a convenient storage location for quick access to assets the user is likely to eventually want to order and ordering means actually initiating playout of the media asset.

In an embodiment, content server 102 is a Video-media preview/viewing (VOD) server providing VOD sessions to clients 104. Content server 102 can also provide subscription on demand (SVOD) sessions to clients 104. Content server 102 may also be a video game server. It is to be appreciated that the content server 102 could provide any type of audio/visual media. Media preview/viewing sessions as described herein refer to any content that is, generally, available for delivery to an individual client device 104, with delivery initiated upon a recommendation from recommendation engine 111 or an explicit request from that client device 104. Media preview/viewing sessions may also be referred to as a “session” herein. Content server 102 may also be referred to as a “server” herein. As depicted in FIG. 1, content server 102 may be part of a cable headend. Alternatively, content server 102 may be coupled to, or connected through, a separate headend 105 or data center (not shown). In an example, a media preview/viewing session is one or more of a video-media preview/viewing (VOD) session, or a video game session wherein video game assets can be previewed and ordered. In a VOD session, content server 102 may provide action-enabled previews of media stored on media server 108. In a video game session, content server 102 runs a video game, for example, on processor 112 and allows a client device 104 to play a preview of the video game remotely.

According to example embodiments, client 104a may be a personal computer, a laptop computer, a tablet computer, an electronic book reading device, an Apple IPAD™, a portable media device such as an Apple IPOD™, a WiFi device, a cellular device, a smart phone, or any other computational device that can receive previews and program material from content server 102 via network 106 either through wires or wirelessly. For example, display device 120a may be an integrated display within a mobile phone.

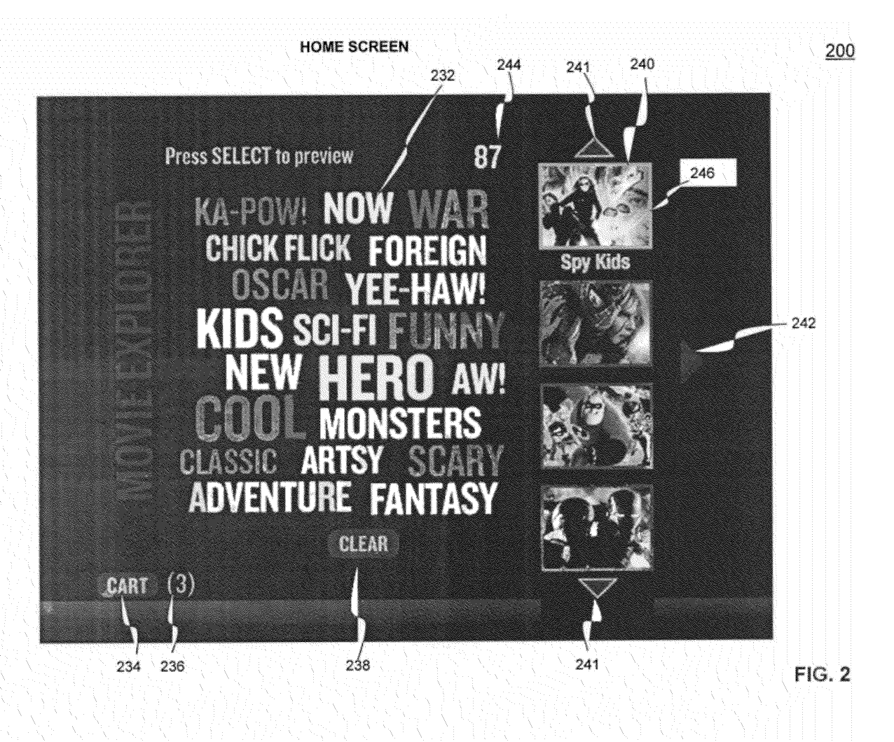

According to an embodiment, system 100 displays a UI (shown in FIGS. 2-7) on display device 120. In embodiments, display device 120 may be one or more of a television, a network-enabled television, a monitor, the display of a tablet device, the display of a laptop, the display of a mobile phone, or the display of a personal computer. The UI includes a home screen, preview screen and related screen (See FIG. 2) which display a keyword cloud and poster art for a series of previews associated with media assets.

In an embodiment, client device 104b is a cable set top box (STB) connected to a display device 120b. In this embodiment, display device 120b may be a television or monitor connected to STB 104b.

Network 106 may be one of or a combination of a cable network such as Hybrid Fiber Coax, Fiber To The Home, Data Over Cable Service Interface Specification (DOCSIS), Internet, Wide Area Network (WAN), WiFi, Local Area Network (LAN), ATM or any other wired or wireless network. Content server 102 includes media server 108 that may provide content such as video over cable network, video over internet, video games over a cable network, video games over the internet or any other type of media over any type of network. Media server 108 may store and stream media including but not limited to photos, video, music and video games. For example, VOD assets may be stored on and streamed from media server 108.

Arrangements according to the present invention can provide automatic, action-enabled previews enabling improved user interaction with program material. The previews can be associated with a set of programs selected based on user input, such as selection by keyword, or genre, or selection of all available programs. Alternatively, the previews can be associated with program material that is recommended, by recommendation engine 111, to a user based upon program material previously ordered via a navigation device such as client 104a or STB 104b. The recommended previews can be associated with demographic information for the user and/or a user profile stored in a user profile database (not shown). The user profile database may be stored locally within content server 102 or remotely. An interactive interface displayed on display devices 120a, 120b . . . 120n enable users of the respective client devices to take actions with respect to previews while program material associated with the previews is presented on the display devices.

### Content Server and Media/Video Explorer

According to an embodiment of the invention, media/video explorer (MVX) module 109 on content server 102, upon receiving a request 122 from a client device 104 to preview one or more media assets, initiates a video on demand session to display action-enabled previews of a plurality of media assets within an interactive interface on display device 120 of client device 104. In an embodiment, media server 108 uses the session to stream previews of media for display via display devices 120 of client devices 104. In an alternative embodiment, multiple video on demand sessions may be used, such as a separate session for each preview.

According to an embodiment, selection module 110 is configured to perform predictive filtering of preview assets (i.e., previews) as an aspect of recommendation engine 111. In an embodiment, filtering performed by selection module 110 is based strictly on explicit user selection, rather than any prediction. In another embodiment, selection module selects all assets, either in a specified category or list, or available in the entire system, without performing any filtering. As depicted in the exemplary embodiment of FIG. 1, selection module 110 is separate from recommendation engine 111, which is configured to receive input from selection module 110. As shown in the exemplary embodiment of FIG. 1, recommendation engine 111 and selection module 110 are independent components of content server 102, with recommendation engine 111 being configured to feed information, such as the identities of preview assets, to MVX module 109. MVX module 109, in turn, requests playout of specific preview assets from content server 102 via media server 108. For example, recommendation engine 111 may be configured to receive input from MVX module 109. Such input may include, but is not limited to user criteria such as keywords, genre, moods, themes, etc., or possibly a specific media asset (in order to find other similar assets). According to this embodiment, recommendation engine 111 returns either all matches sorted into an order based on the predicted interest level of the user, or possibly a subset of the matches.

In an embodiment, media server 108 serves (i.e., plays out) preview assets and media associated with the preview assets as requested by MVX module 109. The preview assets requested by MVX module 109 can optionally be based in part on previews identified by recommendation engine 111 and selection module 110. That is, media server 108 does not to act as a controller or coordinator of which previews are recommended, selected and played in system 100. Instead, MVX module 109 controls and coordinates which previews are selected and played in system 100. According to an embodiment, recommendation engine 111, in conjunction with selection module 110, can coordinate which previews are played by media server 108.

In an embodiment of the invention, the list of previews is merely a list maintained by MVX module 109. According to this embodiment, when one preview ends, the next preview on the list is automatically requested. However, if a user manually requests to jump to the next, or a different, preview, then MVX module 109 will immediately terminate the current preview and jump to the next or requested preview.

In the exemplary embodiment illustrated in FIG. 1, MVX module 109 may insert the selected, recommended previews as requests 122 in a queue, for example queue 121, so that separate requests 122 are started for media preview/viewing session for each client device 104. MVX module 109 starts the preview session by streaming the previews of media from media server 108 for the client device 104. It is to be appreciated that MVX module 109 may be implemented in hardware, software, firmware or any combination thereof.

In an embodiment, MVX module 109 automatically starts streaming and playing previews associated with a set of media assets. For example, MVX module 109 may start previewing a set of media assets upon detecting a period of inactivity within an interactive interface displayed on display device 120. In another embodiment, MVX module 109, in conjunction with selection module 110 and recommendation engine 111 sends previews to the client device 104 user using a given client device 104 based upon the user's previous preview/media viewing sessions/purchases. In an embodiment, MVX module 109 starts previewing media assets in response to determining that a user using client device 104 has initiated a session within a UI displayed on display device 120. In one embodiment, the period of time is a random period of time. In another example, the period of time is a pre-determined period of time. In a further example, the period of time is determined by MVX module 109. In a further example, the period of time is determined by MVX module 109 based on a number of recommended previews identified by recommendation engine 111.

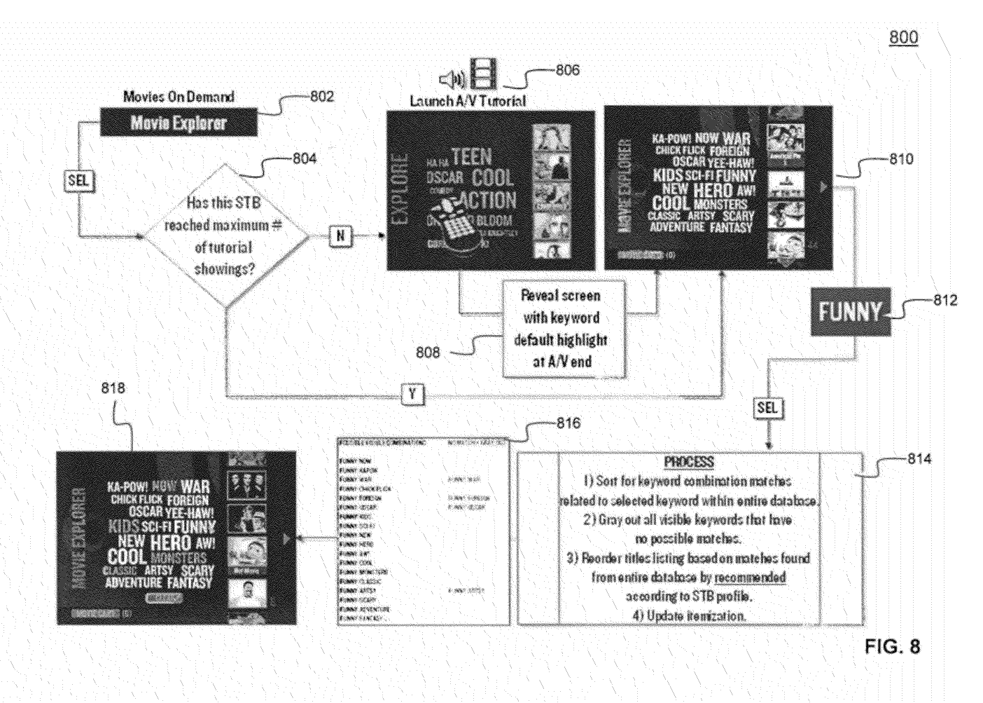

In an example, memory 124 of content server 102 stores instructions on content server 102 that when executed by processor 123 of content server 102, cause processor 123 to perform the steps in the flowchart of FIG. 8.

### Client Device

In an embodiment, client device 104 sends a request for a preview or a media asset associated with a preview being viewed to content server 102. In an embodiment, client device 104 receives user input via an interactive GUI displayed on display device 120 of client device 104 to determine if the user would like client device 104 to view a preview associated with a media asset in full screen mode. Alternatively, previews may be automatically streamed to a client device 104 associated with a user or household based on that user's or that households media preferences, user/household profile information, and/or order history.

In an example embodiment, memory 128 of client device 104 may store instructions locally that when executed by processor 126 of client device 104, cause processor 126 to perform the steps in the flowchart of FIGS. 8.

### Example Graphical User Interface

FIGS. 2-7 depict a graphical user interface (GUI) for browsing and discovering available media assets. In an embodiment of the invention, graphical user interface (GUI) described above with reference to FIG. 1 may include the exemplary interface illustrated in FIGS. 2-7. FIGS. 2-7 are described with continued reference to the embodiment illustrated in FIG. 1. However, FIGS. 2-7 are not limited to those embodiments. Throughout FIGS. 2-7, interfaces are shown with various hyperlinks, command regions, banners, keywords, navigational controls, buttons, poster art thumbnails, icons, pointers, and data fields, which are used to initiate action, invoke routines, select previews, view interactive previews, order media items (i.e., media assets), or invoke other functionality. For brevity, only the differences occurring within the figures, as compared to previous or subsequent ones of the figures, are described below.

FIGS. 2-7 illustrate an exemplary GUI comprising interfaces for viewing and selecting previews, such as the previews recommended by recommendation engine 111 in system 100 described above with reference to FIG. 1, in accordance with an embodiment of the invention. In an embodiment, the GUI depicted in FIGS. 2-7 may be displayed on a display device 120, such as a TV or monitor, coupled to STB 104b (See FIG. 1). In accordance with an embodiment of the present invention, the GUI may be launched by MVX module 109 from content server 102. Alternatively, the GUI may be executed locally on client devices 104 using local processor 126 and memory 124.

With reference to FIG. 2, the exemplary user interface initially displays a home screen 200 with a filmstrip 240 representing an unfiltered list of all available media assets, and a count 244 of the total number of media assets in the list. The exemplary interface as shown reflects only pay-per-view video on demand (VOD) assets, however, the list may include any media asset, including subscription video on demand (SVOD) asset and currently-airing or future-scheduled linear broadcast programs.

According to an embodiment, the initial list may optionally be sorted according to a variety of criteria, including according to predicted level of interest to user, based on user profile information and a recommendation engine. In an alternative embodiment, the system may initially restrict the list represented by the filmstrip 240 to a subset of available media assets.

A user, using an input device (not shown) may refine the list of media assets by selecting one or more keywords from the word cloud 232. As shown in home screen 200, the word cloud 232 contains various keyword terms associated with the list of media assets. Selecting any given term from word cloud 232 limits the list of media assets to only those assets associated with the selected term. If more than one term is selected, only those assets associated with every selected term are included in the list. The count 244 of matching assets is updated as terms are selected from word cloud 232.

As shown in the exemplary embodiment of FIG. 2, a total number of a la carte VOD, SVOD, or media asset titles (element 236) is initially presented in the lower far-left home screen quadrant adjacent to “Cart” banner 234 and to the left of filmstrip 240 and poster-art 246. A user, using an input device, may select a keyword from within word cloud 232 to cull a media assets (i.e., titles) enumerated in count 244. As described in Table 2 and shown in FIG. 2, the clear banner 238 is a visual indicator to a user that a clear button on an input device can be selected to reset word cloud 232 to its default state (i.e., its state at the invocation of the current screen). In an embodiment, clear banner 238 is grayed-out until user selects a keyword that alters the default state (and causes button to be selectable and active/un-gray). In the example embodiment of FIG. 2, clear banner 238 is active because a keyword from word cloud 232 has been selected. Clear banner 238 appears in any interface where there is a word cloud 232.

With continued reference to FIG. 2, up and down arrows 241 are visual indicators to a user that up and down arrows on an input device (not shown) will allow the user to scroll through filmstrip 240.

In another embodiment, the list may include assets matching any of the selected terms. Terms made available for selection may reflect any criteria, including genre, age (i.e., new release vs. library title), format (high definition/HD vs. standard definition/SD), and popularity. In an alternative embodiment, a selection may be made from a conventional list of options, rather than word cloud 232, and the system may enable only single term selection, rather than multiple term selection. Terms may also be organized in a hierarchy, as in a conventional VOD navigation system. Any system of selecting a subset of assets may be used, so long as it results in producing a list of media assets of potential interest.

At any time, the user may begin previewing the current list of assets, including immediately upon entering the application, when the list includes all available assets. In the exemplary system, this can be achieved by using a remote control input device to navigate to poster art 246 representing one of the media assets and pressing a selection button on the remote control, or by navigating to the right arrow 242 on the display and either selecting or arrowing further right using the remote control device.

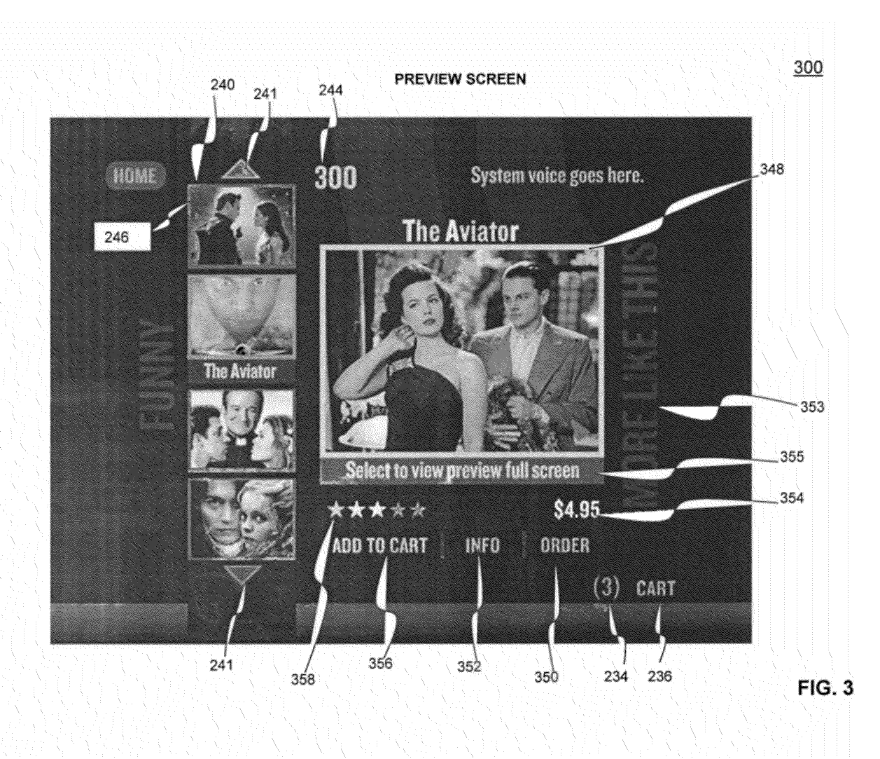

FIG. 3 illustrates an exemplary preview screen 300 interface for previewing a selected list of related media assets. FIG. 3 is described with continued reference to the embodiment illustrated in FIG. 2. However, FIG. 3 is not limited to that embodiment.

In the exemplary preview screen 300 interface provided in FIG. 3, system 100 automatically begins previewing the asset whose poster art 246 was previously selected. Absent further user input, the system will, substantially continuously, display previews for each media asset in the list, according to its order in the filmstrip 240. During playback, the exemplary interface automatically advances a highlight in the filmstrip 240 to reflect the currently previewing asset, as well as updating the title display, rating information 358, and pricing information 354. According to an embodiment, the exemplary preview screen 300 interface automatically scrolls the filmstrip 240 as the previews advance.

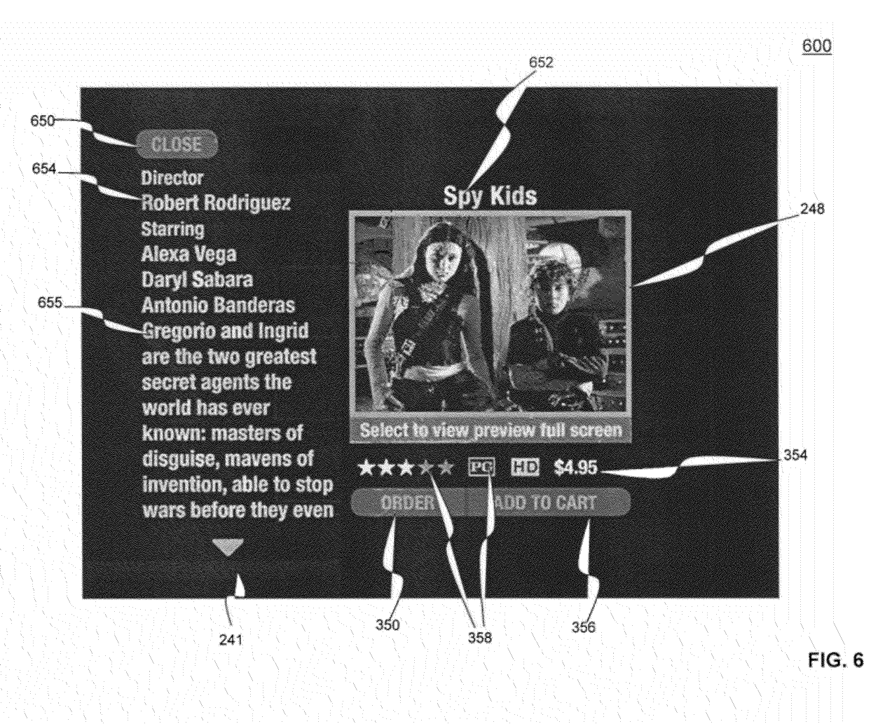

In accordance with embodiments of the invention, ratings information 358 can comprise a Motion Picture Association of America (MPAA) rating (e.g., “PG-13”—see FIG. 6) and/or an indication of aggregate ratings from critics and user communities (i.e., identified groups of users from within preview system 100). As noted in Table 2 below, in one embodiment, the community rating of a title can be displayed in preview screen until a user chooses to rate the asset themselves and may be derived from aggregated VOD/media asset sales in combination with box-office sales (popularity) or third party data (i.e., user ratings databases external to preview video system 100). That is, ratings information 358 can indicate aggregate media ratings from user communities external to asset preview system 100. In the embodiment provided in FIG. 3, ratings information 358 includes an indication of an aggregate number of stars out of a maximum (i.e., three out of five stars). For example, user ratings, such as a viewer's critique of an On Demand title can be aggregated on a per set top box (STB) basis. Once a user rating is submitted, a media asset title can display the user rating instead of the community rating. According to an embodiment, user ratings influence recommendation engine 111 and can be modified at any time.

While a preview is playing in preview window 348, the user may undertake a variety of actions relevant to the media asset associated with the preview, or to select among previews. In the exemplary system, the user may advance to a preview of the next asset in the list by pressing a particular key on a remote control input device (not shown). The user may alternatively move back to the preview of the prior asset in the list by pressing another particular key on the remote control. The user may additionally jump to the preview for any other asset in the list by navigating through the filmstrip 240 to highlight the poster art 246 associated with the desired asset, and pressing a selection button on the remote control. In the exemplary interface, absent further user input, the system will automatically advance to the preview for the next asset in the list (and circularly back to the top of the list, in the case of the last asset in the list), when the current preview ends.

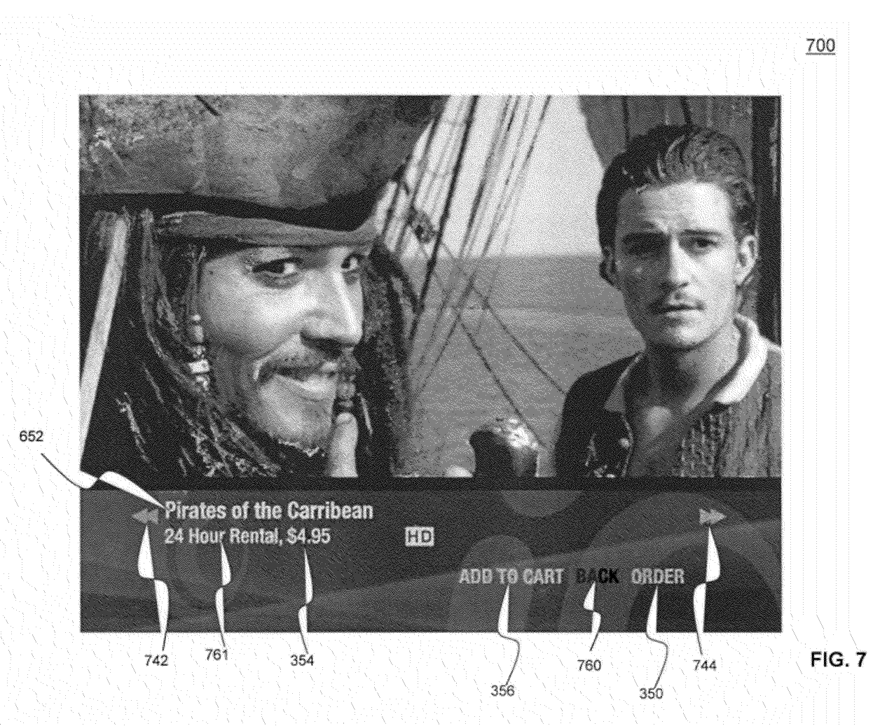

While a preview is playing in preview window 348, the user may also take actions with respect to the asset associated with the preview. For example, the user may click the “Add to Cart” button 356, to save the asset for fast retrieval at a later time. In accordance with an embodiment of the invention, the exemplary interface 300 does not interrupt playback of the preview (or sequence of previews) in response to this action. In an alternative embodiment, the system might immediately advance to the next preview upon the user adding the currently-previewing asset to their movie cart. A user may select full screen preview link 355 to view the preview in full screen mode (see FIG. 7).

In an alternative embodiment, if the interface displayed previews for future-scheduled linear broadcast programs, the system might include a “Record” button to allow easy scheduling of a future recording, on a DVR or network DVR system. The system might also include a “Showings” button to display the various times at which the linear program is scheduled to be broadcast, and to allow selection of a specific broadcast for recording. In an alternative embodiment where the interface also displays currently-airing media, the system might include a “Tune” button (not shown), allowing the user to immediately tune the airing program associated with the preview.

In another alternative embodiment, if the preview playing is associated with a film or live production being shown in theaters, preview screen 300 may enable users to purchase one or more tickets to see the performance. Alternatively, if physical media, such as a DVD is associated with the preview, the system may enable users to purchase a copy of the asset on physical media such as DVD.

In the exemplary interface, the user may also initiate ordering the asset being previewed for immediate viewing by clicking the “Order” button 350. While initiating an order need not immediately terminate the preview process, successfully completing an order does terminate the preview process with playback of the ordered media asset.

The exemplary interface for preview screen 300 additionally allows the user to display information about the currently airing preview by clicking the “Info” button 352. This action displays the information screen of FIG. 6, without interrupting the preview. The exemplary interface's information screen displays additional information about the asset, allows a user who has already seen the program to rate it (not shown), in order to train the exemplary system's recommendation engine, and allows the user to order or save the currently previewing asset.

In the exemplary interface, the sequence of previews continues within the information screen. Absent user intervention, when the current preview ends, the system automatically advances to the preview for the next asset in the list. In addition, the user may manually advance to the next preview or skip back to the previous preview using buttons on a remote control, as previously described for the preview screen of FIG. 3.

Returning to the preview screen of FIG. 3, the exemplary interface allows the user to highlight the preview and click a selection button on a remote control to switch to a full screen preview mode, depicted in FIG. 7. This preview mode enables substantially the same actions and navigation among previews as described for the preview screen and information screen, but with previews playing full screen with a bottom third graphic overlay, rather than as scaled video within full screen graphics windows.

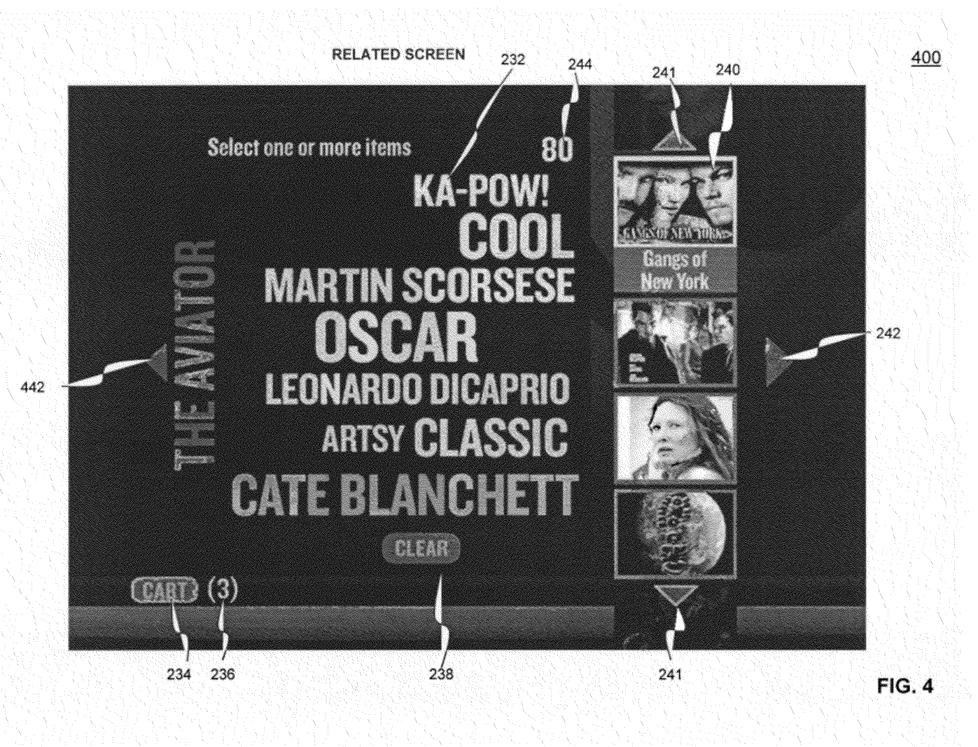

With continued reference to preview screen 300 of FIG. 3, the exemplary interface additionally allows the user to view a list of media assets that are similar or related to the current preview, by navigating to and selecting the “More Like This” link 353. As described in table 2 below, in an embodiment, link 353 includes a general textual term (e.g., “More Like This”) that is non-focusable but indicates to the user the direction he needs to take to access related items in direct relation to the media asset title currently streaming in preview window 348. Upon selecting this link, the exemplary interface displays the related content screen of FIG. 4 (related screen 400, described below). The exemplary interface automatically selects media assets deemed related to the previewing asset, for example, including other assets with the same actors, directors, writers or other extended cast members, assets with a similar genre, mood or theme, and/or assets that the recommendation engine predicts to be of interest to viewers interested in the previewing asset.

FIG. 4 depicts a related content screen 400. FIG. 4 is described with continued reference to the embodiments illustrated in FIGS. 2 and 3. However, FIG. 4 is not limited to those embodiments.

The related content screen 400 of FIG. 4 functions substantially the same as the home screen 200 of FIG. 2. However, the initial list of assets represented in the filmstrip 240 is a subset of available assets that are deemed related to the previous previewing asset, and the keyword terms included in the word cloud 232 are determined based on the specific list of related assets. In the example illustrated in FIG. 4, count 244 indicates there are 80 related assets as compared to 300 assets indicated in count 244 of FIG. 3.

As shown in FIG. 4, the initial list of assets represented in filmstrip 240 is a subset of available assets that are deemed related to the previous previewing asset, and the keyword terms included in the word cloud 232 are determined based on the specific list of related assets. In the example illustrated in FIG. 4, count 244 indicates there are 80 related assets as compared to 300 assets indicated in count 244 of FIG. 3.

By selecting, using an input device, left arrow 442, a user can return to the previous screen. In the exemplary embodiment shown in FIG. 4, selecting left arrow 442 returns the user to preview screen 300 of FIG. 3. As shown in FIG. 4 and described in table 2 below, a ‘breadcrumb’ keyword comprising with a media asset title (e.g., “THE AVIATOR”) can be displayed adjacent to left arrow 442. In embodiments, breadcrumb keyword(s) display on sub-screens such as, but not limited to preview screen 300. As shown in the exemplary interface of FIG. 4, breadcrumb keywords can be displayed vertically to the right of the left arrow 442 to indicate current keyword filter selections. In an alternative embodiment, the preview screen 300 of FIG. 3 or the related content screen 400 of FIG. 4 might enable users to find only programs with a specific relation to the previewing asset. For example, system 100 might provide links to find assets associated with each of the cast members or extended cast members.

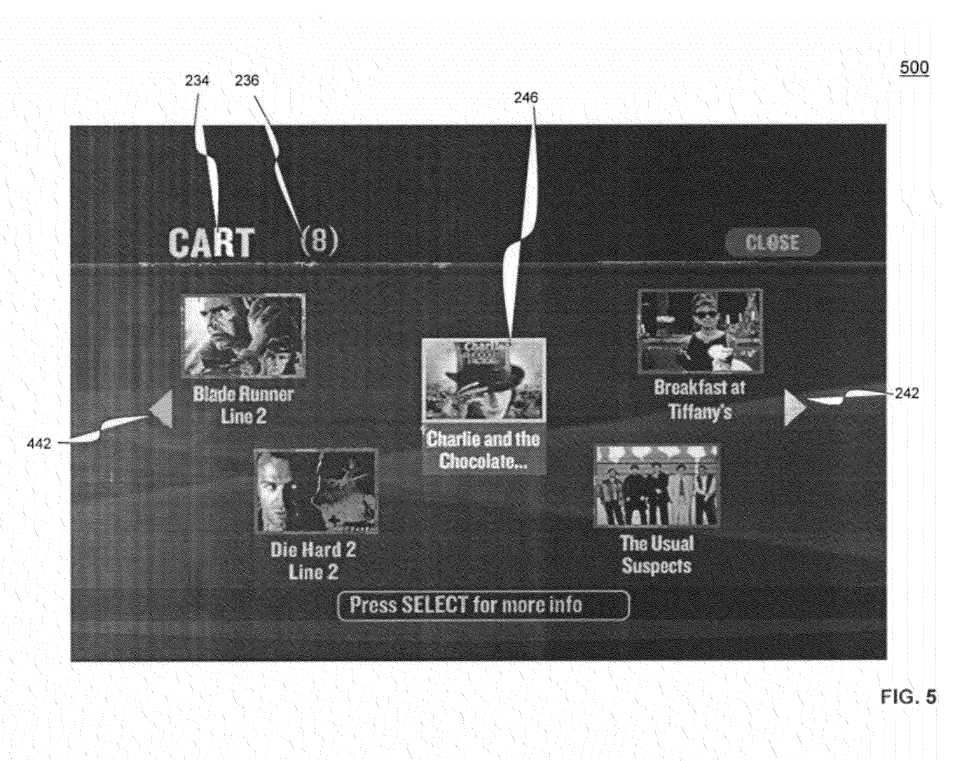

Cart interface 500 of FIG. 5 depicts the movie cart screen of the exemplary interface, where users may store selected assets of interest for fast retrieval, at a later time. FIG. 5 is described with continued reference to the embodiments illustrated in FIG. 2. However, FIG. 5 is not limited to that embodiment.

The movie cart screen enables the user to select a previously saved asset, for ordering, or for other actions including reviewing the asset information and previewing the asset. By navigating to the poster art 246 for an asset in the movie cart, and pressing a selection button on a remote control input device (not shown), the user can display an information screen, as shown in FIG. 6, for the asset. From the information screen 600 of FIG. 6, the exemplary interface automatically previews the assets saved in the user's movie cart, beginning with the selected asset.

FIG. 6 provides an exemplary information screen 600 interface. FIG. 6 is described with continued reference to the embodiments illustrated in FIGS. 2-5. However, FIG. 6 is not limited to those embodiments.

As described below in Table 2 and illustrated in FIG. 6, information screen 600 interface presents a live media preview window of a selected media item with ordering options. A user can exit from information screen 600 by pressing a remote Exit button or by pressing the on-screen “Close” button 650. In addition to displaying a media item's title 652, a streaming interactive preview in preview window 248, ratings information 358, and price 354, information screen 600 displays contributor information 654 and a synopsis 655 of the currently-previewed asset. In an embodiment, contributor information 654 includes, but is not limited to, cast and crew, producer(s), director, production company, studio, animator(s), composer(s), and cinematographer(s). As shown in FIG. 6, a synopsis 655 of the media asset currently being previewed in preview window 248 can be read by scrolling with down arrow 241.

FIG. 7 depicts a full screen preview interface 700, including an interface for viewing a full screen preview. FIG. 7 is described with continued reference to the embodiments illustrated in FIGS. 3 and 6. However, FIG. 7 is not limited to those embodiments.

According to an embodiment of the invention, in response to determining that full screen preview link 355 was selected in the preview screen (see FIG. 3), the full screen preview interface shown in FIG. 7 is launched. By selecting, using an input device, back button 760, a user can return to the preview screen depicted in FIG. 3.

In the exemplary embodiment of FIG. 7, the full screen preview interface 700 displays the media item title 652 for the item being previewed in full screen mode along with the rental term 761, and price 354. As shown in FIG. 7, rental term 761 can indicate the length of a VOD or media asset rental as a duration (i.e., 24 hours). Previous preview arrow 742 is a visual indicator to a user that the rewind button on an input device (not shown) will allow the user to show the previous preview in a sequence of previews. Next preview arrow 744 is a visual indicator to a user that the fast forward button on an input device (not shown) will allow the user to skip to (i.e., advance) the next preview in a sequence of previews.

Table 2 describes general screens and UI elements within the MVX UI discussed above with reference to FIGS. 2-7.

TABLE 2
Interface Screens and Elements

| On-Screen | |
|---|---|
| Element | Description |
| EXPLORE | Explore screen is the “Home” screen for an MVX session. Focus |
| SCREEN | defaults to the keyword recommended as the best filter based on the |
| [a.k.a. | specific set top box profile. In an embodiment, a default keyword |
| HOME | is presented in an interactive graphical user interface (GUI) in |
| SCREEN] | direct proximity to DEFAULT poster art position and can display |
| (Default | in the largest font size/scale according to the template. |
| Screen on | |
| application | |
| invocation. | |
| Branding | The MVX module may present a branded name along with a logo |
| | representing the UI [e.g., Media/Video Explorer]. Branding and/or |
| | logo can be presented in some form on all major screens. |
| HOME | A display of keywords in various font point sizes or scales [e.g., a |
| Explore | range of 18-24 depending on size and positioning]. Keywords can |
| Keyword | extracted from a keyword database that directly relates to a current |
| Cloud | media asset database. Keyword display criteria is then based on a |
| | series of factors that may work in combination with one another or |
| | may be solely based [such as: Genre types (92 Action vs. 2 Urban), |
| | most popular/community, and/or specific user profile [STB and/or |
| | Household]. Keywords when selected act to filter and update the |
| | poster-art list. A maximum of (4) keywords can be selected in |
| | combination for any one filtering instance. Keywords can be |
| | deselected as desired to change the filter results and/or change the |
| | search criteria. The system can cull the total listing in real time to |
| | refine the search specific to the keyword(s) selected or deselected. |
| | Keywords can be navigated using any combination of standard |
| | left/right/up/down scroll or using on-screen mouse/gesture |
| | [hand/wrist left/right/up/down] behavior. |
| Listing of | Maximum of <4> focusable thumbnail poster-art images can be |
| Media Asset | displayed on any given screen (where template applicable). And |
| Poster-art | <2> split, dimmed back thumbnails at the top and bottom of the |
| Thumbnail | listing respectively, with UP/DOWN ARROW elements overlaid. |
| Images | Poster-art images can be highlighted and scrolled within the page. |
| | However, once the user reaches the top or bottom of the visible |
| | page listing, if the user is using gesture pointing navigation, then |
| | the pointer can focus the up or down arrow element. Selecting the |
| | up or down arrow element will act to PAGE up or down. If the |
| | viewer is using standard up/down navigation, then any attempt to |
| | press the up or down remote arrow will not focus the on screen |
| | arrow element but in fact will auto page up or down. Listing of |
| | poster-art can be navigated using any combination of standard |
| | left/right/up/down scroll or using on-screen mouse/gesture behavior |
| | [acceleration and control]. Filtered poster-art titles always reflect |
| | most recommended for the set top box profile. |
| Asset cart <# | The feature has a two-fold action. The feature is represented as a |
| of Titles> | banner in the lower-third of the screen and the “Asset cart” button |
| banner | rests on the banner. Asset cart banner is presented on all major |
| | screens. Asset cart is identical to a shopping cart basket whereby |
| | users can grab, drag, and drop poster-art into the cart on the fly. |
| | The user can also specifically select the Asset cart button that rests |
| | on the banner and invoke the full Asset cart bin to see all the saved |
| | images. |
| System | System Voice can provide instruction to the user based on focus |
| Voice | state. In addition to the instruction being dynamic, it may also be |
| | auto-triggered into an animated sequence mode whereby it provides |
| | a rotational series of instructions based on the various functions the |
| | user can perform within the screen. This may take the form of a |
| | “ticker” and auto-scroll horizontally. |
| Left/Right | In screens where user has ability to gesture left or right to transition |
| On-Screen | between two screen regions (e.g., invoking the Preview Screen |
| Arrows | from the Home Screen and vice versa), the user can have the ability |
| | to focus the on-screen left or right arrow element either by pointing |
| | and selecting; by using standard left/right navigation and when |
| | arrow has focus then select; or when using standard left/right |
| | navigation, once arrow has focus then any additional left or right |
| | press can auto-transition to the next/prior screen. The screen can |
| | also be auto-transitioned by using the sweeping gesture motion to |
| | “fling” in the left or right direction. |
| On-Screen | A “clear” button can appear anywhere there is a keyword cloud. |
| CLEAR | Upon selection, acts to reset the keyword cloud to its default state |
| Button | [at invocation of screen]. In effect, start over. Clear button can be |
| | grayed-out until user selects a keyword that alters the default state |
| | [and causes button to un-gray]. |
| On-Screen | Home button appears on sub-screens. Home button can be focused |
| HOME | by gesturing and point directly to the button, or using standard |
| Button | navigation to focus the left-facing on-screen arrow element and |
| | then using the standard up arrow to focus. Selection allows the |
| | user to return directly back to the Home/Explore screen by skipping |
| | all interim screens. Home screen presents in last focus state (prior |
| | to exiting the screen). Note that even though screen will display in |
| | its last state prior to leaving screen initially, all interim screen |
| | history between press of HOME button and return to Home screen |
| | is cleared for forward and back. |
| PREVIEW | Preview screen is accessed by selecting a poster-art image, or using |
| SCREEN | left/right navigation as outlined in Left/Right On-Screen Arrows |
| | description, from within the Home/Explore or any Related screen. |
| | Invocation of the Preview screen simultaneously acts to |
| | automatically launch a video preview associated with the title last |
| | highlighted, gestured over, gestured passed, or selected from the |
| | Explore or Related screen. |
| Preview | Preview screen can default focus to the poster-art highlighted |
| Screen | [gestured over, passed, or selected] from the prior screen. The term |
| Default | “Now Previewing” replaces the media asset title within the title |
| Focus Poster- | field beneath the poster-art. |
| Art | |
| Media asset | Media asset title is non-focusable and sits above the expanded |
| Title above | preview window to the right of the poster-art title listing. Two lines |
| Preview | can be supported to present the media asset title and title should |
| Window | break at a full word if it requires two lines [no single characters or |
| | partial words]. |
| Previewing | The Preview video window sits below the media asset title center |
| video | screen. The window can be highlighted and selected. Below the |
| window | video window but still within the window frame sits the preview |
| w/streaming | window instruction field. Selection of the preview window acts to |
| VOD | take video full screen. |
| Media Rating | The rating presented under the preview window for all media titles |
| | presented on the Preview screen can present community and/or |
| | critic ratings and can be non-focusable and non-interactive. |
| MPAA | Metadata for each media asset is non-focusable and presented |
| Rating, Run | directly below the media asset preview window. |
| Time, Price | |
| Order Button | Acts to invoke order popup overlay. |
| Details | Acts to invoke media asset Details overlay. |
| Button | |
| Breadcrumb | Breadcrumb keyword(s) display on sub-screens only. Breadcrumb |
| Keyword(s) | keywords display vertically to the right of the left-facing arrow. |
| [left facing | Breadcrumb keywords indicate current keyword filter selections. |
| vertical on | In an embodiment, a maximum of <4> keyword filters in total are |
| any Preview | honored for any given single keyword or keyword combo filter. A |
| or Related | total of two vertical lines can be supported for display of the |
| screen] | keywords. In an embodiment, if keywords exceed a two line max, |
| | then the breadcrumb keywords can be truncated at a full word |
| | followed by an ellipsis. |
| “Related” or | Appears on Preview screens only. General textual term that is non- |
| “More Like | focusable but indicates to the user the direction he needs to take to |
| This” right | access related items in direct relation to the media asset title |
| facing | currently streaming in the preview window. Displays directly in |
| vertical | front of the far right-facing arrow. |
| RELATED | Related keyword screen is accessed when the user gestures or uses |
| SCREEN | standard navigation as outlined in the Left/Right On-Screen Arrows |
| | description. If returning to a prior Preview screen, user would |
| | gesture or select left. |
| Related | A limited display of keywords in various point sizes/scales [e.g., a |
| Keyword | range of 10-14 words depending on scale and positioning]. |
| Cloud | Keywords are extracted from a keyword database that directly |
| | relates to the current title breadcrumb displayed vertically to the far |
| | left of the screen. Keyword display criteria are then based on a |
| | series of factors that may work in combination with one another, or |
| | may be solely based, such as: genre and contributors such as cast |
| | members (i.e., actors, actresses, voice actors, voice actresses, and |
| | stunt people), cinematographers, writers, directors, producers, |
| | illustrators/animators, studios, and other related keywords. |
| | Weighting of poster-art titles is based on the recommendation |
| | engine and user profile. The system can cull the total listing in real |
| | time to refine the search specific to the keyword(s) selected or de- |
| | selected. Keywords can be navigated using any combination of |
| | standard left/right/up/down scroll or using on-screen mouse |
| | hand/wrist left/right/up/down gesture behavior. |
| Itemization | Appears on screens presenting a media asset poster-art title listing. |
| | Itemization displays as a total count of currently filtered media |
| | asset titles. Itemization appears in the lower-third of the screen |
| | directly to the left or right of the media asset poster-art listing |
| | (depending on screen template). Keyword filter searches culls the |
| | total results listing value down or up based on the specific keyword |
| | selection(s) and de-selection(s). |
| Information | A full Screen overlay that presents media information details |
| Screen | [synopsis, attributes, contributors, ordering options, etc.], ability to |
| | user rate the feature, and auto-streams video preview window on |
| | selection or maintains stream during transition between regions |
| | (depending on screen invoked from). |
| Contributors, | Meta data indicating synopses and contributors, such as, but not |
| Synopsis | limited to directors, writers, cinematographers, producers, cast and |
| | crew, appear on a details overlay (i.e., information screen). The |
| | information screen can be accessed by selecting the “Info” button |
| | from any preview screen, or by selecting poster-art image within |
| | Asset cart overlay. |
| Info “Close” | The information screen can be exited by pressing on-screen |
| Button | “Close” button and revealing underlying screen in last focus state. |
| RATE IT | The user rating button initially appears [if never rated] as textual |
| Button - User | RATE IT. Once the user interacts with the RATE IT button, the |
| Rating | button then appears in the last state of user interaction showing the |
| | star values and no longer presents textual RATE IT. The user must |
| | select the button to activate the widget either by pointing or using |
| | standard navigation to focus the button. Once activated arrowing |
| | left/right or SEL (select) and hold gesture left/right action can act to |
| | fill and un-fill the star fields. If gesturing then releasing hold |
| | accepts and deactivates widget, if using standard navigation, then |
| | selecting again can accept. Once the user deactivates the widget |
| | the new rating appears as the user rating. |
| ASSET | Reveals complete bin of saved media asset titles. Titles display as a |
| CART | horizontal list of poster-art images and can be navigated using standard |
| OVERLAY | scroll paradigm. |
| (Full) | |
| Asset cart | The number of titles stored inside the cart can be displayed on- |
| itemization | screen near the overlay header [e.g., “Asset cart (6)]. |
| Asset cart | Thumbnails and screen elements can be traversed via |
| Poster-Art | left/right/Up/Down gesture or arrow selection. Far left/right gesture |
| | or arrow, or page +/−, acts to page forward or back when more than |
| | one page of titles. |
| Asset cart | Closes Asset cart overlay and reveal current underlying screen in |
| “Close” | last focus state. |
| Button | |

Table 4 provides an example of predictive filtering based upon keywords, in accordance with an embodiment of the invention. In an embodiment of the invention, selection module 110 is configured to use the visible keyword combinations listed in Table 4 below. As shown in Table 4, selection module 110 can identify a plurality of results (media asset titles) to be recommended by recommendation engine 111 based upon the visible keyword combinations and matches to meta data indicating attributes of media assets.

TABLE 4
Example of Keyword Predictive
Filtering

| POSSIBLE VISIBLE | | | | |
|---|---|---|---|---|
| COMBINATIONS | NO MATCH = GRAY OUT | RESULTS[TITLES] | NON-VISIBLE COMBOS | RESULTS |
| FUNNY/NOW | | 10 | FUNNY/WESTERN | 2 |
| FUNNY/KAPOW | | 2 | FUNNY/URBAN | 0 |
| FUNNY/WAR | FUNNY/WAR | 0 | ETC . . . | |
| FUNNY/CHICK FLICK | | 1 | | |
| FUNNY/FOREIGN | | 1 | | |
| FUNNY/KIDS | | 3 | | |
| FUNNY/SCI-FI | FUNNY/SCI-FI | 0 | | |
| FUNNY/NEW | | 1 | | |
| FUNNY/HERO | FUNNY/HERO | 0 | | |
| FUNNY/AW! | | 1 | | |
| FUNNY/COOL | | 3 | | |
| FUNNY/MONSTERS | | 3 | | |
| FUNNY/CLASSIC | | 3 | | |
| FUNNY/ARTSY | | 2 | | |
| FUNNY/SCARY | | 3 (=SCARY = REPEAT = VOID) | | |
| FUNNY/ADVENTURE | | 2 | | |
| FUNNY/FANTASY | FUNNY/FANTASY | 0 | | |

### Method Embodiment

FIG. 8 is a flowchart 800 illustrating steps by which action-enabled previews are recommended and displayed, in accordance with an embodiment of the present invention.

More particularly, flowchart 800 illustrates the steps by which a method for recommending and presenting action-enabled previews in a video preview system is performed, according to an embodiment of the present invention.

FIG. 8 is described with continued reference to the embodiments illustrated in FIGS. 1-7. However, FIG. 8 is not limited to those embodiments. Note that some steps shown in flowchart 800 do not necessarily have to occur in the order shown.

The method begins at step 802 where MVX module 109 is invoked. After MVX module 109 launches, the method proceeds to step 804.

In step 804, an evaluation is made regarding whether a tutorial has been shown via a given navigation device (an STB in the example of FIG. 8). In this step, it is determined if a maximum number of tutorial showings have occurred, control is passed to step 810. In an embodiment, the maximum number of showings is configurable/tunable. If it is determined that the maximum number of tutorial showings has not yet occurred, then control is passed to step 806.

In step 806, MVX module 109, upon invocation, auto-launches the tutorial. In the embodiment shown in FIG. 8, the tutorial is an interactive audio/visual (AN) visual tutorial, such as, but not limited to, an instructional animation. As noted above with reference to step 804, the tutorial launched in this step is a “smart” in that it only launches a set number of times before video preview system 100 permanently suppresses the tutorial. In an embodiment, the set number of times is a configurable or tunable value. After the tutorial is launched, control is passed to step 808.

In step 808, a home screen, such as home screen shown in FIG. 2, is launched. In this step, the default word cloud 232 is displayed on the home screen.

The home screen displayed in step 808 includes a listing 244 and poster art 246 for a sequence of previews. In an embodiment, the sequence of previews is determined by recommendation engine 111 in conjunction with selection module 110. After the home screen is displayed, control is passed to step 810.

In step 810, in response to detecting selection of a keyword (e.g., “FUNNY”) or a poster art 246 icon/thumbnail, control is passed to step 812, where a filter is determined for the selected keyword or poster art 246.

In step 812, word cloud 232 and listing 244 are culled based on the selection in step 810. In the example of FIG. 8, the selected keyword is “FUNNY” and mood-based filtering is performed. After the filtering is performed, control is passed to step 814.

In step 814, a process is performed to determine an appropriate word cloud 232, listing 244 and associated poster art 246 for a related screen.

In step 814, according to an embodiment, the process:
1. Sorts keyword combination matches related to the keyword selected in step 810 within the keyword database;
2. Grays out (i.e., make inactive and non-focusable) visible keywords within word cloud 232 having no possible matches with the selected keyword (e.g., “FUNNY”);
3. Reorders media item titles in listing 244 based on matches found in a media asset database (i.e., a database accessible by content server 102), wherein the reordering is based on recommendations from recommendation engine 111. In an embodiment, the reordering and recommendation in this step of the process is based at least in part on a user profile, such as an STB profile (in the example of FIGS. 8); and
4. Updates the itemization of listing 244 to reflect the number of recommended previews.

In step 816, filtering based upon keywords can performed. In accordance with an embodiment of the invention, this step is performed as described above with reference to Table 4 above. For example, selection module 110 can use the visible keyword combinations listed in Table 4 during step 816. In one embodiment, predictive filtering can be employed to accomplish step 816. As shown in Table 4, selection module 110 can identify a plurality of media asset titles to be recommended by recommendation engine 111 based upon the visible keyword combinations and matches to meta data indicating attributes of media assets. After predictive filtering is completed, control is passed to step 818.

In step 818, a related screen is displayed. In an embodiment, the related screen includes the data items described above with reference to related content screen 400 of FIG. 4.

### Example Computer System Implementation

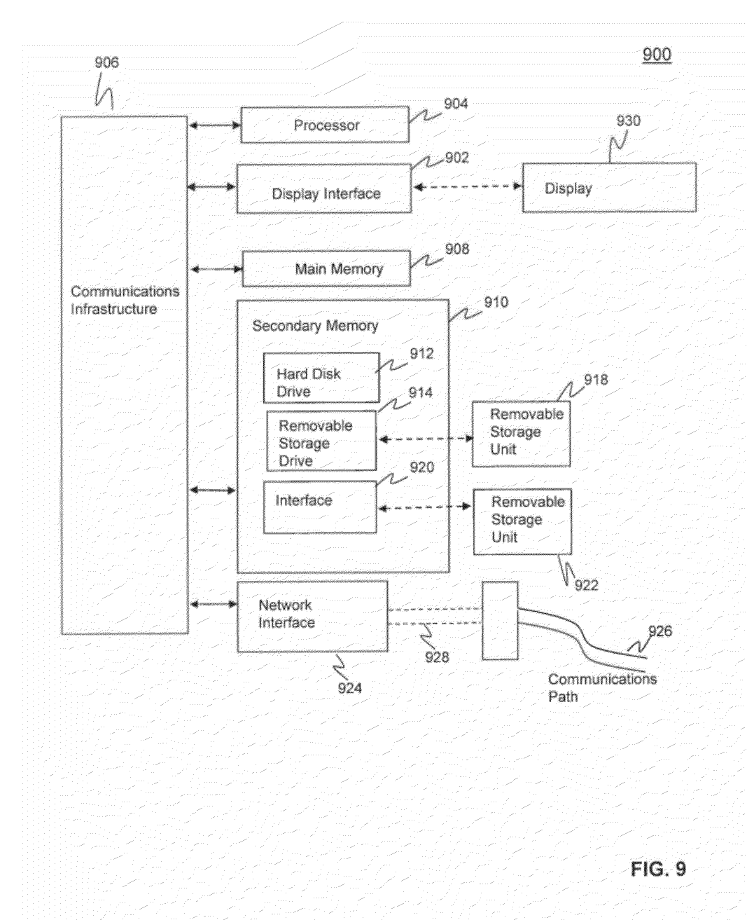

Various aspects of the present invention can be implemented by software, firmware, hardware, or a combination thereof. FIG. 9 illustrates an example computer system 900 in which the present invention, or portions thereof, can be implemented as computer-readable code. For example, the method illustrated by the flowchart 800 of FIG. 8 can be implemented in system 900. System 100 of FIG. 1 can also be implemented in system 900. Various embodiments of the invention are described in terms of this example computer system 900. After reading this description, it will become apparent to a person skilled in the relevant art how to implement the invention using other computer systems and/or computer architectures.

Computer system 900 includes one or more processors, such as processor 904. Processor 904 can be a special purpose or a general-purpose processor. Processor 904 is connected to a communication infrastructure 906 (for example, a bus, or network).

Computer system 900 also includes a main memory 908, preferably random access memory (RAM), and may also include a secondary memory 910. Secondary memory 910 may include, for example, a hard disk drive 912, a removable storage drive 914, flash memory, a memory stick, and/or any similar non-volatile storage mechanism. Removable storage drive 914 may comprise a floppy disk drive, a magnetic tape drive, an optical disk drive, a flash memory, or the like. The removable storage drive 914 reads from and/or writes to a removable storage unit 918 in a well-known manner. Removable storage unit 918 may comprise a floppy disk, magnetic tape, optical disk, etc. which is read by and written to by removable storage drive 914. As will be appreciated by persons skilled in the relevant art(s), removable storage unit 918 includes a non-transitory computer readable storage medium having stored therein computer software and/or data.

In alternative implementations, secondary memory 910 may include other similar means for allowing computer programs or other instructions to be loaded into computer system 900. Such means may include, for example, a removable storage unit 922 and an interface 920. Examples of such means may include a program cartridge and cartridge interface (such as that found in video game devices), a removable memory chip (such as an EPROM, or PROM) and associated socket, and other removable storage units 922 and interfaces 920 which allow software and data to be transferred from the removable storage unit 922 to computer system 900.

Computer system 900 may also include a communications interface 924. Communications interface 924 allows software and data to be transferred between computer system 900 and external devices. Communications interface 924 may include a modem, a network interface (such as an Ethernet card), a communications port, a PCMCIA slot and card, or the like. Software and data transferred via communications interface 924 are in the form of signals, which may be electronic, electromagnetic, optical, or other signals capable of being received by communications interface 924. These signals are provided to communications interface 924 via a communications path 926. Communications path 926 carries signals and may be implemented using wire or cable, fiber optics, a phone line, a cellular phone link, an RF link or other communications channels

Computer system 900 may additionally include computer display 930. According to an embodiment, computer display 930, in conjunction with display interface 902, can be used to display the interactive UI depicted in FIGS. 2-7. Computer display 930 may also be used to display a UI and media on display device 120.

In this document, the terms “computer program medium,” “non-transitory computer readable medium,” and “computer usable medium” are used to generally refer to media such as removable storage unit 918, removable storage unit 922, and a hard disk installed in hard disk drive 912. Signals carried over communications path 926 can also embody the logic described herein. Computer program medium and computer usable medium can also refer to memories, such as main memory 908 and secondary memory 910, which can be memory semiconductors (e.g. DRAMs, etc.). These computer program products are means for providing software to computer system 900.

Computer programs (also called computer control logic) are stored in main memory 908 and/or secondary memory 910. Computer programs may also be received via communications interface 924. Such computer programs, when executed, enable computer system 900 to implement the present invention as discussed herein. In particular, the computer programs, when executed, enable processor 904 to implement the processes of the present invention, such as the steps in the methods illustrated by flowchart 800 of FIG. 8 and system 100 of FIG. 1 discussed above. Accordingly, such computer programs represent controllers of the computer system 900. Where the invention is implemented using software, the software may be stored in a computer program product and loaded into computer system 900 using removable storage drive 914, interface 920, hard drive 912, or communications interface 924.

The invention is also directed to computer program products comprising software stored on any computer useable medium. Such software, when executed in one or more data processing device, causes a data processing device(s) to operate as described herein. Embodiments of the invention employ any computer useable or readable medium, known now or in the future. Examples of computer useable mediums include, but are not limited to, primary storage devices (e.g., any type of random access memory), secondary storage devices (e.g., hard drives, floppy disks, CD ROMS, ZIP disks, tapes, magnetic storage devices, optical storage devices, MEMS, nanotechnological storage device, etc.), and communication mediums (e.g., wired and wireless communications networks, local area networks, wide area networks, intranets, etc.).

### CONCLUSION

While various embodiments of the present invention have been described above, it should be understood that they have been presented by way of example only, and not limitation. It will be understood by those skilled in the relevant art(s) that various changes in form and details may be made therein without departing from the spirit and scope of the invention as defined in the appended claims. It should be understood that the invention is not limited to these examples. The invention is applicable to any elements operating as described herein. Accordingly, the breadth and scope of the present invention should not be limited by any of the above-described exemplary embodiments, but should be defined only in accordance with the following claims and their equivalents.

What is claimed is:

1. A method for presenting previews of media items in a media delivery system having an interactive interface, comprising:
generating a first set of media items of potential interest to a user;
creating an ordered list of the set of media items; and
displaying, in the interactive interface, a sequence of previews for the set of media items,

2. The method of claim 1, wherein the sequence is based in part on the predicted relevance or interest level for the user.

3. The method of claim 2, wherein the predicted relevance or interest level for the user is based in part on user profile data.

4. The method of claim 2, wherein the predicted relevance or interest level for the user is based in part on user input received via the interactive interface.

5. The method of claim 1, wherein the displaying begins automatically after the creating.

6. The method of claim 1, wherein the generating comprises:
generating a set of media items based in part upon genres of a plurality of media items.

7. The method of claim 1, wherein the generating comprises:
generating a set of media items based in part upon input received in one or more menus within the interactive interface.

8. The method of claim 7, wherein the input received includes one or more keywords for a keyword search.

9. The method of claim 1, wherein the set of media items comprise one or more of:
video on demand assets:
video games;
movies; and
television programs.

10. The method of claim 9, wherein the video-on-demand assets comprise pay-per-view assets.

11. The method of claim 1, further comprising accepting a user command, during the displaying of the sequence of previews, without terminating the display of the sequence of previews immediately upon receiving the command.

12. The method of claim 11, wherein the command is one of: move ahead to the next preview in the sequence, move back to the previous preview in the sequence, restart the current preview from the beginning, or move to a non-adjacent preview in the sequence.

13. The method of claim 11, wherein the command adds one or more media items associated with the currently displaying preview to a second set of media items.

14. The method of claim 13, wherein the second set is a set of media items that interest the user.

15. The method of claim 13, wherein the second set is a set of media items that disinterest the user.

16. The method of claim 11, wherein the command is to schedule recording of one or more media items associated with the currently displaying preview,

17. The method of claim 11, wherein the command is to tune a channel associated with the currently displaying preview.

18. The method of claim 11, wherein the command is to generate a second set of media items based at least in part on the media item associated with the currently displaying preview.

19. The method of claim 18, wherein the second set of media items is generated based, at least in part, on media items having at least one contributor in common with a media item associated with the currently-displaying preview.

20. The method of claim 19, wherein the at least one contributor includes one or more of:
a writer;
a cinematographer;
an illustrator;
a studio;
a director;
a producer;
a production company; and
a cast member, wherein a cast member includes one or more of an actor, an actress, a voice actor, a voice actress, and a stunt person.

21. The method of claim 18, wherein the second set of media items is generated based, at least in part, on media items having at least one of genre, mood, theme, or rating in common with a media item associated with the currently-displaying preview.

22. The method of claim 18, wherein the second set of media items is generated based, at least in part, on at least one of predicted relevance, a user profile, or collaborative filtering.

23. The method of claim 11, wherein the command is to order at least one of:
a physical copy of a media item for purchase, a physical copy of a media item for rental, or at least one theater ticket to see a media performance;
wherein said media item or media performance is associated with the currently-displaying preview.

24. The method of claim 11, wherein the command is to show options for ordering at least one of:
a physical copy of a media item for purchase, a physical copy of a media item for rental, or at least one theater ticket to see a media performance;
wherein said media item or media performance is associated with the currently-displaying preview.

25. The method of claim 11, wherein the command is to show information associated with the media item associated with the currently-displaying preview.

26. The method of claim 1, further comprising accepting a user command, during the display of the sequence of previews, to order one or more media items associated with the currently displaying preview.

27. The method of claim 26, wherein the ordered one or more media items ordered are available for purchase and wherein the ordering initiates purchase of the selected one or more media items.

28. A system for presenting previews of media items, comprising:
a selection module configured to select a first set of media items of potential interest to a user;
a sequencing module configured to create an ordered list of the set of media items; and
a display module configured to present, in an interactive user interface, a sequence of previews for the set of media items.

29. The system of claim 28, wherein the sequence is based in part on the predicted relevance or interest level for the user.

30. The system of claim 29, wherein predicted relevance or interest level for the user is based in part on user profile data.

31. The system of claim 29, wherein the predicted relevance or interest level for the user is based in part on user input received via the interactive interface.

32. The system of claim 28, wherein the display module is further configured to automatically begin presentation of the sequence of previews.

33. The system of claim 28, wherein the selection module is further configured to select a set of media items based in part upon genres of a plurality of media items.

34. The system of claim 28, wherein the selection module is further configured to select a set of media items based in part upon input received in one or more menus within the interactive interface presented by the display module.

35. The system of claim 34, wherein the input received includes one or more keywords for a keyword search.

36. The system of claim 28, wherein the set of media items comprise one or more of:
video on demand (VOD) assets;
video games;
movies; and
television programs.

37. The system of claim 36, wherein the VOD assets comprise pay-per-view assets.

38. The system of claim 28, further comprising an input device configured to accept a user command, during the display of the sequence of previews, without terminating the display of the sequence of previews immediately upon receiving the command.

39. The system of claim 38, wherein the command is one of move ahead to the next preview in the sequence, move back to the previous preview in the sequence, restart the current preview from the beginning, or move to a non-adjacent preview in the sequence.

40. The system of claim 38, wherein the command adds one or more media items associated with the currently displaying preview to a second set of media items.

41. The system of claim 40, wherein the second set is a set of media items that interest the user.

42. The system of claim 40, wherein the second set is a set of media items that disinterest the user.

43. The system of claim 38, wherein the command is to schedule recording of one or more media items associated with the currently displaying preview.

44. The system of claim 38, wherein the command is to generate a second set of media items based at least in part on the currently displaying preview.

45. The system of claim 44, wherein the second set of media items is generated by the selection module based, at least in part, on media items having at least one contributor in common with a media item associated with the currently-displaying preview.

46. The system of claim 45, wherein the at least one contributor includes one or more of:
a writer;
a cinematographer;
an illustrator;
a studio;
a director;
a producer;
a production company; and
a cast member, wherein a cast member includes one or more of an actor, an actress, a voice actor, a voice actress, and a stunt person.

47. The system of claim 44, wherein the second set of media items is generated based, at least in part, on media items having at least one of genre, mood, theme, or rating in common with a media item associated with the currently-displaying preview.

48. The system of claim 44 wherein the second set of media items is generated based, at least in part, on at least one of predicted relevance, a user profile, or collaborative filtering.

49. The system of claim 38, wherein the command is to order at least one of:
a physical copy of a media asset for purchase, a physical copy of a media item for rental, or at least one theater ticket to see a media performance;
wherein said media item or media performance is associated with the currently-displaying preview.

50. The system of claim 38, wherein the command is to show options for ordering at least one of:
a physical copy of a media item for purchase, a physical copy of a media item for rental, or at least one theater ticket to see a media performance;
wherein said media item or media performance is associated with the currently-displaying preview.

51. The system of claim 38, wherein the command is to show information associated with the media item associated with the, currently-displaying preview.

52. The system of claim 28, further comprising accepting a user command, during the display of the sequence of previews, to order one or more media items associated with the currently displaying preview.

53. The system of claim 52, wherein the one or more media items ordered are available for purchase and wherein the ordering initiates a purchase of the selected on or more media items.
